(19) United States
(12) Patent Application Publication
(10) Pub. No.: US 2009/0262260 A1
(43) Pub. Date: Oct. 22, 2009

(54) MULTIPLE-DISPLAY SYSTEMS AND METHODS OF GENERATING MULTIPLE-DISPLAY IMAGES

(75) Inventors: Christopher O. Jaynes, Denver, CO (US); Stephen B. Webb, Lexington, KY (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: MERSIVE TECHNOLOGIES, INC., Lexington, KY (US)

(21) Appl. No.: 12/425,896

(22) Filed: Apr. 17, 2009

Related U.S. Application Data
(60) Provisional application No. 61/045,640, filed on Apr. 17, 2008.

(51) Int. Cl. H04N 9/31

(52) U.S. Cl. 348/744; 348/E09.025

(57) ABSTRACT

A display system includes a first and second display source configured to generate first and second images that overlap to form a multiple-display image. Each illuminated point within an overlap region includes a first image pixel contribution generated by the first display source and a second image pixel contribution generated by the second display source. The display system is programmed to select one or more dithering pixels within the overlap region and apply a blending function that alters one or more radiometric parameters of pixels within the overlap region. The blending function includes a deterministic blending function that alters contribution of non-dithering pixels based at least in part on the location of the non-dithering pixel within the overlap region. The blending function also includes a dithering component that alters contributions of dithering pixels within the overlap region of multiple-display image based at least in part on a modification value X.

### CROSS REFERENCE TO RELATED APPLICATIONS

This application claims the benefit of U.S. Provisional Application Ser. No. 61/045,640, filed on Apr. 17, 2008, for Perceptually Deconstructive Algorithms for Multi-Projector Color and Intensity Blending.

### BACKGROUND

Displays that are composed of multiple, overlapping projected images typically require a color and intensity blending function to be applied to pixels within the overlapping regions. These functions may attenuate the projected intensity or color values of the pixels in order to achieve a more uniform brightness and color across any overlap region.

For example, a two display system utilizing projectors may have a partial overlap region. Without a blending function, the overlapping region in the display will be approximately twice as bright as the non-overlapping region. A simple blending function may then be expressed as I′=I/n(x, y). Where I′ is the output intensity, I is the input intensity of any given display and n(x,y) is the number of displays that illuminate position (x,y) in the display. In this two display example, this blending function would then halve the intensity of each projector in the overlap.

However, this blending function may introduce artifacts at the boundary between full display brightness in the non-overlapping regions and modified display brightness in the overlapping region. This occurs because of potential error in the alignment of the displays (e.g., a pixel thought to be in the overlap region may actually lay just outside or partially outside) as well as global differences in the brightness levels of the displays. For example, if one display is generally darker than the other, this blending approach may induce a display with three distinct “stripes” of brightness, one for each display at full intensity and a third that is somewhat darker in the overlap region than the non-overlap region of the bright projector but somewhat brighter than the dark projector.

Further, the human visual system is very good at detecting consistent features, however faint, in a scene. For example straight edges, consistent color gradients, and corners are all detected by the human visual system easily and are observed with very little evidence. These features are all spatially varying functions of brightness that are consistent features in the scene. The human visual system is capable of detecting these “patterns” even with scant evidence. The same is true for temporally consistent patterns. Consistent visual artifacts are easily “grouped” together into a single gestalt that can lead to a larger perceived artifact in the displayed image. In particular, many slight edges can be grouped into a single edge artifact due to intensity differences that span regions in the blending where there is, in fact, no edge at all.

Accordingly, alternative display systems and methods that reduce the appearance of image artifacts in a multiple image display are desired.

### SUMMARY

According to one embodiment, a display system is provided. According to the embodiment, the display system includes at least a first and second display source. The first and second display sources are configured to generate respective first and second images having a plurality of illuminated points onto a display surface. The first and second images generate a multiple-display image, wherein at least a portion of the first image overlaps at least a portion of the second image in an overlap region. Each illuminated point within the overlap region includes a first image pixel contribution generated by the first display source and a second image pixel contribution generated by the second display source. The display system is programmed to select one or more dithering pixels P_{d}(x,y) from the pixels within the overlap region. The display system is further programmed to apply a blending function to the first and second display sources, wherein the blending function alters one or more radiometric parameters of the first and second image pixel contributions of pixels within the overlap region. The blending function includes a deterministic blending component that alters one or more radiometric parameters of the first and second image pixel contributions of any non-dithering pixels P(x,y) based at least in part on the location of the non-dithering pixel P(x,y) within the overlap region. The blending function also includes a dithering component that alters one or more radiometric parameters of the first and second image pixel contributions for one or more dithering pixels P_{d}(x,y) within the overlap region of multiple-display image based at least in part on a modification value X.

According to another embodiment, a method of displaying a multiple-display image includes generating a first and second image comprising a plurality of illuminated points on a display surface to generate a multiple-display image including the first and second images. At least a portion of the first image overlaps at least a portion of the second image in an overlap region of the multiple-display image such that each illuminated point within the overlap region of the multiple-display image includes a first image pixel contribution generated by the first display source and a second image pixel contribution generated by the second display source. The method also includes selecting one or more dithering pixels P_{d}(x,y) from the pixels within the overlap region and altering one or more radiometric parameters of the first and second image pixel contributions for any non-dithering pixels P(x,y) within the overlap region based at least in part on the location of the non-dithering pixel P(x,y) within the overlap region. The method further includes altering one or more radiometric parameters of the first and second image pixel contributions for one or more dithering pixels P_{d}(x,y) within the overlap region based at least in part on the location of the dithering pixel P_{d}(x,y) within the overlap region and a modification value X.

According to yet another embodiment, a display system including a first display source and a second display source is provided. The first and second display sources are configured to generate respective first and second images having a plurality of illuminated points on a display surface, thereby generating a multiple-display image comprising the first and second images. The first display source and the second display source are configured such that at least a portion of the first image overlaps at least a portion of the second image in an overlap region of the multiple-display image, wherein each illuminated point within the overlap region of the multiple-display image comprises a first image pixel contribution generated by the first display source and a second image pixel contribution generated by the second display source. The display system is programmed to sequentially apply two or more blending functions to the first and second display sources, wherein the blending functions are configured to alter one or more radiometric parameters of the first and second image pixel contributions for one or more pixels P(x,y) within the overlap region of the multiple-display image.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a schematic illustrating an exemplary display system according to one or more embodiments;

FIG. 2A illustrates an exemplary multiple-display image according to one or more embodiments;

FIG. 2B illustrates an exemplary multiple-display image according to one or more embodiments;

FIG. 2C illustrates an exemplary multiple-display image according to one or more embodiments;

FIG. 2D illustrates an exemplary multiple-display image according to one or more embodiments;

FIG. 2E illustrates an exemplary multiple-display image according to one or more embodiments;

FIG. 3 is an illustration of an exemplary overlap region according to one or more embodiments;

FIG. 4 is an illustration of an exemplary overlap region according to one or more embodiments; and

FIG. 5 illustrates an exemplary Perlin noise model according to one or more embodiments.

### DETAILED DESCRIPTION

Referring to the drawings, embodiments of the present invention may improve intensity or color blending in overlap regions of an image generated by multiple display sources by applying spatially and/or temporally varying blending functions to the display sources to attenuate visible artifacts in the image. The blending functions described herein may be utilized to blend the images of the overlap region by introducing a deconstructive pattern that attenuates gestalt features within the image while still retaining an radiometric parameter value that, at each pixel, the contribution of energy from each display source sums to a desired value. Display systems and methods of displaying multiple-display images will be described in more detail herein.

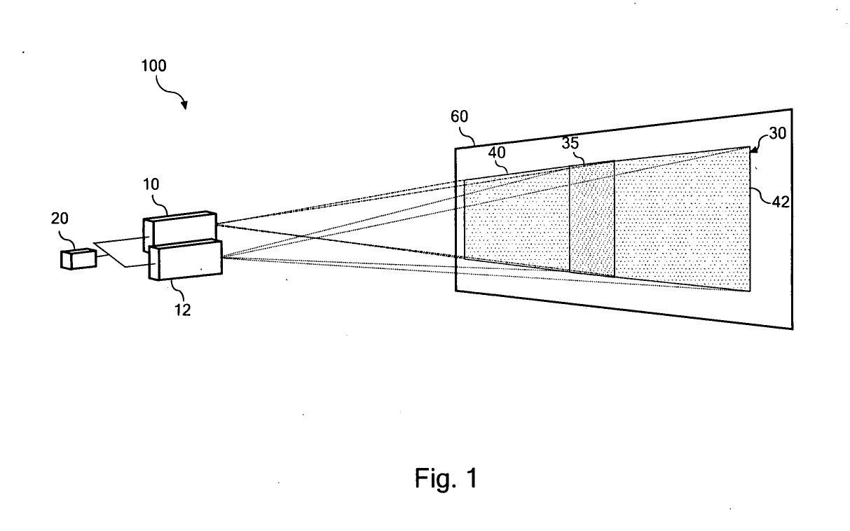

Referring to FIG. 1, an exemplary display system is illustrated. In the embodiment, a first and second display source 10, 12 projects a first and second image 40, 42 onto a display surface 60 (e.g., a screen or a wall) to form a multiple-display image 30 comprising a plurality of illuminated points. The illuminated points of the multiple-display image 30 are defined as illuminated areas on the display surface 60 that are generated by pixel contributions of the display sources 10, 12. The first and second display sources 10, 12 may be projectors configured for emission of optical data to generate moving or static images. In some embodiments, the display sources 10, 12 may be controlled by a system controller 20, which may be a computer or other dedicated hardware. In other embodiments, the display system may not comprise a system controller 20. For example, one of the display sources may operate as a master and the remaining display source or sources as a slave or slaves.

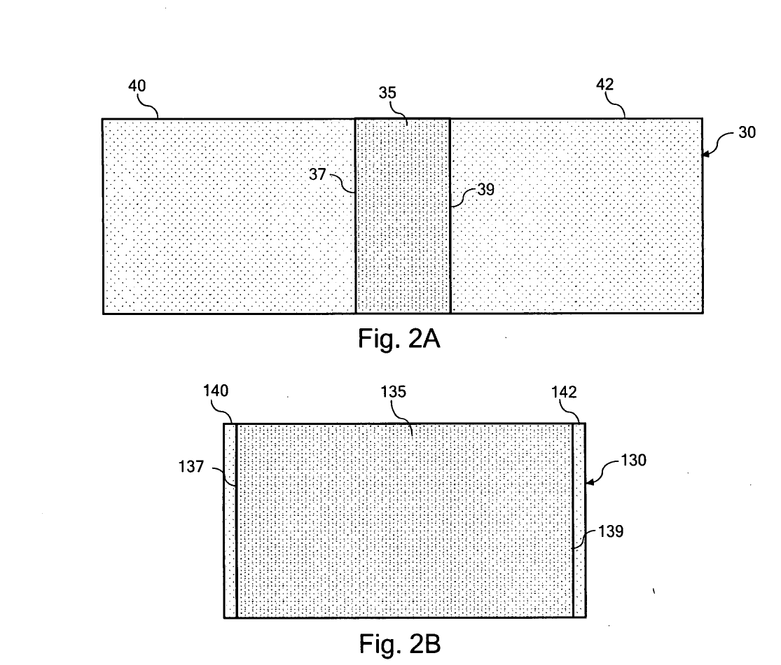

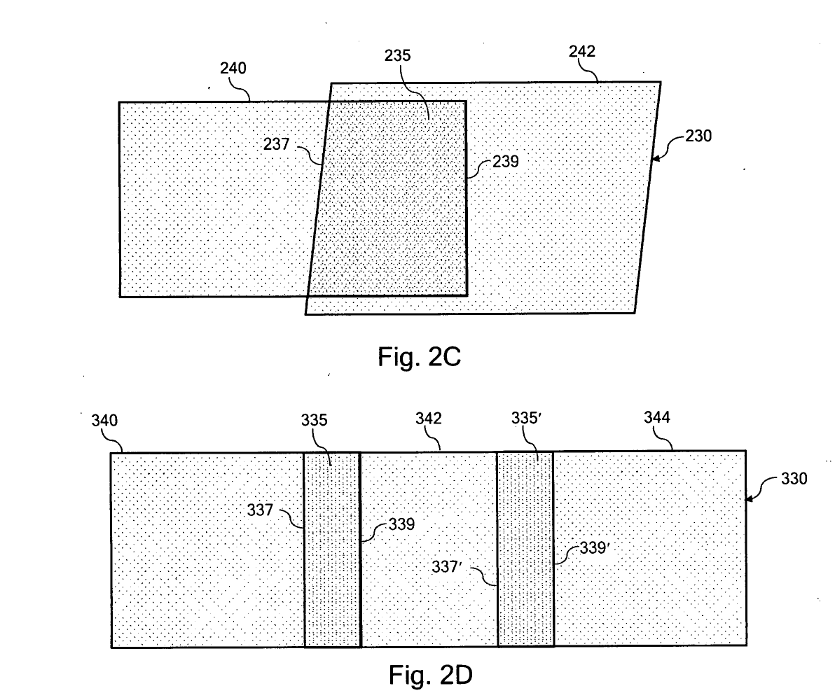

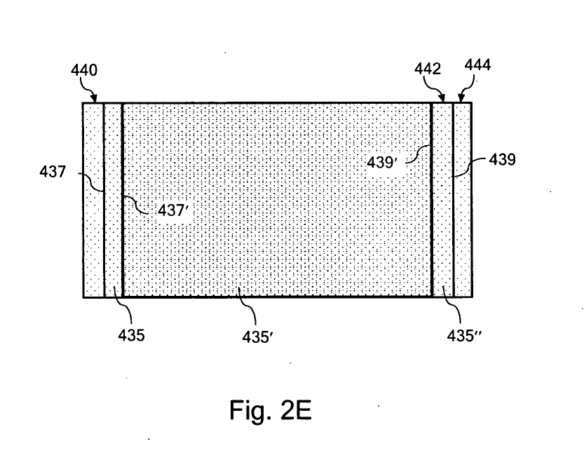

Referring now to FIGS. 1-2E, the first and second images 40, 42 may overlap one another in an overlap region 35. The overlap region 35 is defined in part by the termination of the first image 40 at border 39 and the termination of the second image 42 at border 37. The overlapping images may be arranged in a variety of configurations. FIG. 2A illustrates a multiple-display image 30 having a relatively narrow overlap region 35, while the multiple-display image 130 illustrated in FIG. 2B has an overlap region 135 that is a significant portion of the total image 130. FIG. 2C illustrates a multiple-display image 230 having an irregularly shaped second image 242 that defines an irregularly shaped overlap region 235. It will be understood that the multiple-display image may comprise more than two overlapping images in display systems having more than two display sources. For example, FIG. 2D illustrates a multiple-display image having three overlapping images 340, 342 and 344 that define two overlap regions 335 and 335′. FIG. 2E illustrates a multiple-display image generated by three display sources (440, 442 and 446) having an overlap region 435′ that contains contributions from the three display sources and two overlap regions 435 and 435″ that contain contributions from two out of the three display sources.

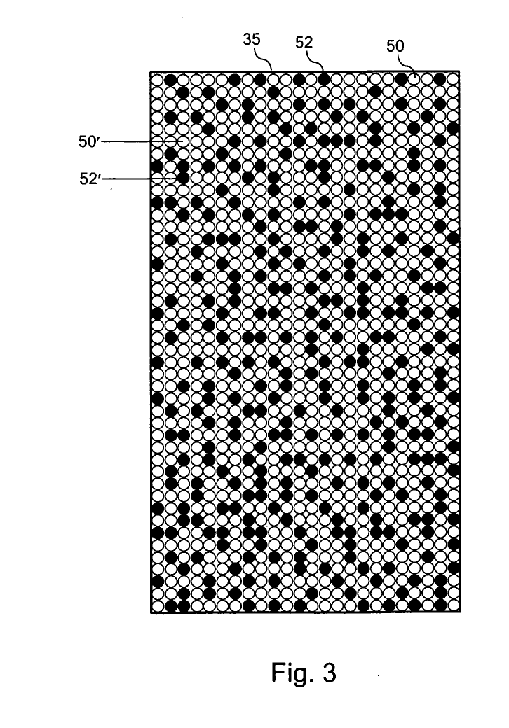

As illustrated in FIGS. 1 and 3, the first and second display sources may be arranged such that the pixels generated by the first display source substantially overlap the corresponding pixels of the generated by the second display source within the overlap region 35 (see FIG. 3). FIG. 3 is a representation of an overlap region 35 having a plurality of pixels (e.g., 50 and 52) therein. FIG. 3 is for illustrative purposes only, as the overlap region may contain more or fewer pixels. In the illustrated embodiment, each pixel P(x,y) within the overlap region is illuminated by a first image pixel contribution provided by the first display source 10 and a second image pixel contribution provided by the second display source 12. The image pixel contribution comprises radiometric parameters such as intensity (i.e., brightness) and color value. Color values may include a red, blue or green color value. Embodiments of the present disclosure may be used to blend the radiometric parameters of a variety of color spaces, such as YCbCr, for example. Display sources may also be configured to generate multi-spectral imagery.

To generate a multiple-display image that has minimal visible artifacts, the radiometric parameters of the first and second pixel contributions for each pixel within the overlap region 35 should be adjusted so that the total radiometric parameter value O (e.g., an intensity value I) of the pixels within the overlap region 35 match pixels outside of the overlap region 35 that have a similar total radiometric parameter value O. As described above, if each display source generating the multiple-display image 30 illustrated in FIGS. 1 and 2 were to produce the total intensity value I for each pixel within the overlap region, the overlap region 35 would be approximately twice as bright as the portions of the multiple-display image 30 that are outside of the overlap region 35.

Display systems of the present disclosure may be programmed to apply a blending function to the display sources (e.g., first and second display source 10, 12) to change the contribution amount provided by the display sources to the pixels (e.g., 50, 52) within the overlap region based upon the location of the pixel P(x,y) within the overlap region. For example, a blending function may attenuate projected intensities of the first and second display sources 10, 12 based on a particular pixel's distance to the border of an overlap region. The blending function assigns a relative percentage of the total radiometric parameter value O at a given pixel in a display based on the ratio of the distances from that particular pixel P(x,y) to each of the display sources forming the overlap region.

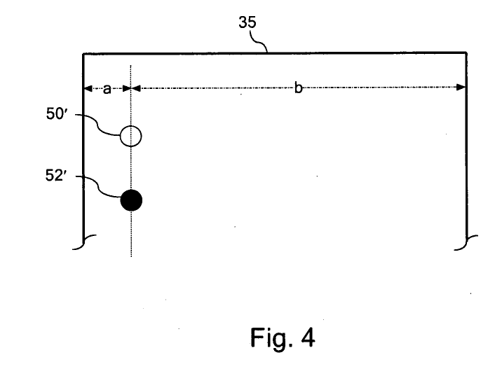

Embodiments of the present disclosure may utilize a blending function that comprises a deterministic blending component and a dithering component to effectively remove visible artifacts from the generated image. The term “deterministic” is defined herein as a value or a function that is not random. For example, a determinist blending component may be “deterministic” because the value it provides may be determined by pixel location. Referring to FIGS. 3 and 4, consider a particular pixel 50′ in the overlap region 35 that is 2 units (distance a) away from border 37 (i.e., the termination of the second image 42 as illustrated in FIGS. 1 and 2) and 22 units (distance b) from border 39 (i.e., the termination of the first image 40 as illustrated in FIGS. 1 and 2). If the total intensity at the point is to be I, the first display source should contribute

$$I \times ( \frac{b}{( a + b )} )$$

while the second display source should contribute

$$I \times ( \frac{a}{( a + b )} )$$

to the particular pixel 52′ in accordance with a deterministic blending component of the blending function. In this example, pixel 50′ is blended under this exemplary deterministic blending component by using approximately 91% of the energy from the first display source 10 and 9% of the energy from the second display source 12. It will be understood that other deterministic functions may be utilized for the deterministic blending component of the blending function, such as those blending functions that do not rely on the position of the pixel within the overlap region 35.

The deterministic blending function described above may alleviate the problems described herein because it will induce a smoother “ramp” between the two display sources. However, the inventor has recognized that perceptual artifacts relating to the deterministic ramping blending function described above also exist.

Rather than deterministically selecting the amount of energy to be contributed by overlapping display sources based on pixel location, embodiments of the present disclosure utilize a blending function comprising a dithering component that incorporates one or more probability distribution functions at some or all pixels within the overlap region 35. The dithering component, which may incorporate a random or pseudo-random variable, or a non-random component that is not based on the location of the particular pixel within the overlap region 35, may be any function that aids in deconstructing the global artifacts that arise when only applying deterministic blending functions to the display sources (e.g., first display source 10 and second display source 12). The blending functions of the present disclosure, as described below, may spatially and/or temporally incorporate an element into the display source contributions of some or all of the pixels within the overlap region 35 to dither the image by altering image contributions of the pixels such that the appearance of global artifacts are minimized.

In one embodiment, dithering pixels P_{d}(x,y) having a dithering component of the blending function applied thereto may be selected from the pixels within the overlap region 35. FIG. 3 illustrates a manner in which a display system according to one embodiment of the present disclosure may be programmed to implement the blending functions as described herein. Dithering pixels P_{d}(x,y) 52 (the darkened pixels) are selected amongst the pixels that are within the overlap region 35 while leaving the unselected non-dithering pixels 50 P(x,y) (the white pixels).

The dithering pixels P_{d}(x,y) 52 may be deterministically or randomly (or pseudo-randomly) selected in accordance with a function, such as a probability distribution function. For example, the display system may be programmed to select the dithering pixels based on a uniform distribution of some value so that a certain percentage of the pixels within the overlap region will be selected as a dithering pixel P_{d}(x,y) 52 and therefore be perturbed by the dithering component. As an example and not a limitation, the uniform distribution may provide for a 60% chance that any given pixel within an overlap region 35 of the multiple-display image 30 will be selected as a dithering pixel P_{d}(x,y) 52. The display system may also be programmed to select the dithering pixels based on other distribution functions or methodologies. In some embodiments, the display system may be programmed to select every pixel within the overlap region or regions as a dithering pixel P_{d}(x,y) 52.

Display systems of the present disclosure may then be programmed to apply the deterministic blending component described above to the first and second display sources 10, 12 (or any additional display sources) such that the first and second pixel contributions of each non-dithering pixel P(x,y) 50 (if any) are assigned a percentage of the total radiometric parameter value based upon the position of the particular non-dithering pixel P(x,y) 50 within the overlap region. It is contemplated that the deterministic blending component may utilize other deterministic functions to be applied to the first and second pixel contributions.

For the dithering pixels P_{d}(x,y), the display system in some embodiments is programmed to introduce a random or pseudo-random function into the underlying deterministic blending function. In other embodiments, the display system is programmed to introduce a deterministic value that is not entirely based on the position of the pixel within the overlap region 35. In this manner, a dithering component of the blending function is applied to each of the dithering pixels P_{d}(x,y). Embodiments of the present disclosure may utilize a random, pseudo-random or deterministic modification value X with a value between one and zero that is then assigned to the relative energy assignments of the contributions determined by the deterministic component, such as the deterministic component described above. The modification value X may be selected from one or more dithering probability distribution functions and may randomly alter the assigned energy assignments of the contributions provided to each of the dithering pixels P_{d}(x,y). For example, if intensity of the each of the dithering pixels P_{d}(x,y) is the radiometric parameter of interest and I is the total intensity that should appear at a particular dithering pixel (e.g., pixel 52′), an exemplary function of a dithering component having two display sources may be expressed as follows:

For the first display source:

$$I * ( \frac{( \frac{b}{a + b} ) * x}{( ( \frac{b}{a + b} ) * x ) + ( ( \frac{a}{a + b} ) * ( 1 - x ) )} ) .$$

For the second display source:

$$I * ( \frac{( \frac{a}{a + b} ) * ( 1 - x )}{( ( \frac{b}{a + b} ) * x ) + ( ( \frac{a}{a + b} ) * ( 1 - x ) )} ) .$$

According to the above function, the modification value X, which may be randomly selected from a distribution function, is applied to the assigned percentage of the first pixel contribution while (1-X) is applied to the assigned percentage of the second pixel contribution. The modified percentages are then weighted such that the applied pixel contributions equal the total desired intensity I at the particular dithering pixel P_{d}(x,y).

Referring to exemplary dithering pixel 52′ of FIG. 3, like non-dithering pixel 50′, this pixel is also 2 units (distance a) away from border 37 and 22 units (distance b) away from border 39. Therefore, under the deterministic component, the first display source 10 should contribute approximately 91% and the second display source 12 should contribute approximately 9% of the total intensity I. Assuming a modification value X of 0.3 is selected from a dithering probability distribution function for dithering pixel 52′, the dithering component now provides for a first image pixel contribution of approximately 83% and a second image pixel contribution of approximately 17%. In this manner the applied contributions under the dithering component are based on the position of the dithering pixel P_{d}(x,y) and the modification value X. In other embodiments, the modification value may be applied directly to the first and second image pixel contributions such that the contributions are only based on the modification value X and not the location of the particular dithering pixel P_{d}(x,y). Using the above example, the first image pixel contribution may be 30% and the second image pixel contribution may be 70%.

By applying the dithering component of the blending function for each dithering pixel P_{d}(x,y), the blending function is not only dependent on the spatial location of the pixel, and therefore a spatial dithering effect may be created that destroys the visible artifacts that result from the use of deterministic blending functions. It will be understood that the above function for the dithering component is an example and is used by way of depiction only. Any function or variable that modifies the underlying blending function may be utilized to provide this dithering effect, and the dithering function does not necessarily have to be random. For example, a deterministic dithering function that is not based on pixel location may be used. The probability function only needs to impact, in some way, the underlying spatial blending function. It will also be understood that the same function may be applied to each of the color channels (e.g., red R, green G and blue B) in a multiple display system in order to select the appropriate color contribution of each display source at any given point on the display surface, or a different function may be applied to each color channel.

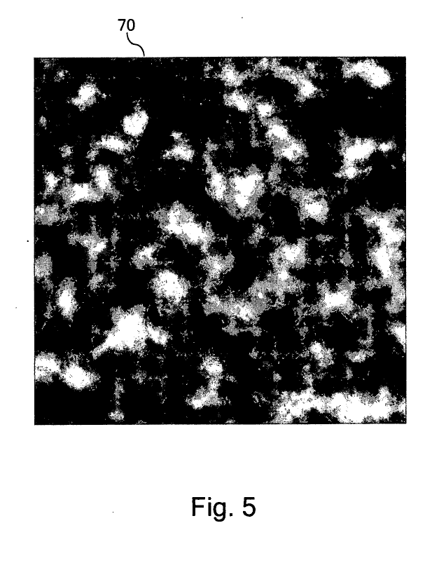

In one embodiment, the dithering component may utilize a dithering probability distribution function that is a Perlin noise model that is known for its ability to simulate “natural” randomness. The noise model is a composition of multiple frequency response curves (harmonics), each with a controllable weight that determines the amount of a particular frequency that will be present in the final noise map (i.e., the output pattern). An example of a Perlin noise model pattern 70 is illustrated in FIG. 5. The noise function generates a two-dimensional probability distribution function (or table) comprising points that correspond spatially with the pixels of the multiple-display image. The noise model may then be used at the time of blending the overlapping portions of the images provided by the multiple display sources. For example, the modification value X may be determined by the value of the point in the Perlin noise model that corresponds to a particular dithering pixel P_{d}(x,y).

Any probability distribution function may be used to determine a randomized contribution weight from each display source in the display system and/or whether or not to select a pixel as a dithering pixel P_{d}(x,y). A multi-band frequency function Perlin noise model described above is only one such function. Others probability distribution functions may include, but are not limited, to parametric distributions (e.g., Gaussians and Cauchy distributions), uniform distributions, non-parametric distributions (e.g., a 2D lookup table), or discrete distributions (e.g., a binomial distribution). Fundamentally, these distributions describe the probability, both in likelihood and magnitude, that impacts the underlying spatial blending function.

When blending the overlap region, the probability distribution function or 2-D table may be used to determine what percentage of energy should be assigned to each of the display sources. The result is that gestalt structures, due to deterministic methods for assigning relative energy to each projector, are convoluted with the “noise” from a non-deterministic model. The probability distribution function only needs to impact the spatially varying blending function in a way that now assigns energy to each projector that is not determined by a spatially varying function alone.

In some embodiments, the probability distribution function that is used to select the dithering pixels P_{d}(x,y) may be the same as the probability distribution function that is used to determine the modification value X. For example, the display system may be programmed such that the dithering pixels P_{d}(x,y) are selected by sampling a probability distribution function (e.g., a Perlin noise model) having points that correspond to the pixels of the multiple-display image. The points, each of which has an associated function value (e.g., between 0 and 1), may correspond to the pixels of the multiple-display image or to only those pixels within the overlap region or regions. By sampling the probability distribution function, a function value may be assigned to each pixel within the overlap region. Sampling the probability distribution function may be simply reading the function value at each point of the noise model that corresponds to the pixels of interest. The sampled function values may then be compared with a reference value, which may be predetermined. If the function value of a particular pixel P(x,y) meets a selection criteria, such as, for example, if the function value is greater than the reference value, the pixel may then be designated as a dithering pixel P_{d}(x,y). Then, the probability distribution function may be sampled to obtain the modification value X that is to be applied to each of the dithering pixels P_{d}(x,y) that are to be modified by the dithering component of the blending function.

The probability distribution function that determines if the dithering component should be applied at a particular pixel in the display and the probability distribution function that determines the magnitude of energy change (e.g., modification value X) of each display in the multiple-display image do not have to be the same function. As an example and not a limitation, a uniform distribution of 0.6 may be utilized to determine if a pixel should be selected as a dithering pixel P_{d}(x,y) and a Perlin noise model may be utilized to determine the magnitude of the energy change at the particular pixel. In this case, there is a 60% chance that any given pixel P(x,y) within an overlapping region will be perturbed by the noise function (a random variable would have to fall in the range 0.0-0.6). Once it is determined that the pixel should be modified by the dithering component, then a second random function (e.g., the Perlin noise model) may be used to determine the modification value X that effects the contribution of energy between the overlapping display sources 10, 12.

The blending and probability distribution functions described herein above may also be applied temporally to a sequence of varying images, each with a blending function that can, but does not have to, vary in time. In these embodiments, the probability distribution function is a function that varies in time. The blending function can be modified by a random function that changes over time.

By way example, consider a Perlin noise model that describes a probability distribution function that modifies the blending function at each pixel P(x,y). This function may be a two-dimensional function written as p(x,y). By sampling p at the point (x,y) it may be determined 1) if the underlying blending function should be modified (i.e. if a random variable exceeds the value at p(x,y), and 2) a random amount of energy that should be applied to the corresponding pixel P(x,y) by drawing a random sample from the underlying probability distribution function. By extending this to a temporally varying blending function, the probability distribution function is now a three-dimensional function p(x,y,t) and, at each pixel in space and time, this function describes the random model of energy change in an underlying deterministic blending function.

Spatially varying blending functions that are not necessarily randomized may also be used to remove temporal consistency that arises from a single deterministic blending function. Embodiments of the present disclosure may utilize deconstructive blending methods that apply a sequence of different blending functions over time. Although each of these blending functions may not be random, by changing the blending function over time, a pattern that once was apparent in time can be attenuated. In this manner, the radiometric parameters associated with the pixels of the multiple-display image may be dependent upon both the position of the pixels and time. For example, a display system may be programmed to sequentially apply four deterministic blending functions A, B, C, and D. One of the blending functions may be the blending function described above where the contributions per pixel are determined based on the location of the particular pixel. The other blending functions may be variations of this blending function or a blending function that is not based on the location of the pixel. The display system may then be programmed to apply the blending functions A, B, C, and D in sequence over time. Because each blending function creates different artifacts and artifact patterns, and the blending functions are applied in sequence, the human eye will average the different artifacts and patterns so that the artifacts and patterns are no longer detectable to the observer. In this manner, the quality of the image may be improved.

It is noted that the particular noise model and the method in which it is combined to determine the relative energy assignments of the pixel contributions is not limited to the examples provided herein. Rather, the general approach presented herein can make use of any appropriate technique to generate the deconstructive noise, both in space and time, and any appropriate method that combines the output of the utilized noise model into a consistent blend across multiple displays.

It is noted that recitations herein of a component of the present invention being “configured” or “programmed” to embody a particular property, function in a particular manner, etc., are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the terms “substantially” and “approximately” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue. The term “substantially” is further utilized herein to represent a minimum degree to which a quantitative representation must vary from a stated reference to yield the recited functionality of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A display system comprising a first display source and a second display source, wherein:
the first display source is configured to generate a first image comprising a plurality of illuminated points on a display surface and the second display source is configured to generate a second image comprising a plurality of illuminated points on the display surface, thereby generating a multiple-display image comprising the first and second images;
the first display source and the second display source are configured such that at least a portion of the first image overlaps at least a portion of the second image in an overlap region of the multiple-display image, wherein each illuminated points within the overlap region of the multiple-display image comprises a first image pixel contribution generated by the first display source and a second image pixel contribution generated by the second display source; and
the display system is programmed to:
select one or more dithering pixels P_{d}(x,y) from pixels within the overlap region; and
apply a blending function to the first and second display sources that alters one or more radiometric parameters of the first and second image pixel contributions of pixels within the overlap region, wherein:
the blending function comprises a deterministic blending component that alters one or more radiometric parameters of the first and second image pixel contributions of any non-dithering pixels P(x,y) based at least in part on the location of the non-dithering pixel P(x,y) within the overlap region; and
the blending function comprises a dithering component that alters one or more radiometric parameters of the first and second image pixel contributions for one or more dithering pixels P_{d}(x,y) within the overlap region of multiple-display image based at least in part on a modification value X.

2. A display system as claimed in claim 1 wherein the dithering component alters the one or more radiometric parameters of the first and second image pixel contributions based at least in part on the location of the dithering pixel P_{d}(x,y) within the overlap region and the modification value X.

3. A display system as claimed in claim 1 wherein the radiometric parameter comprises an intensity parameter or a color channel parameter.

4. A display system as claimed in claim 1 wherein:
the overlap region comprises a first border defined by a termination of the first image and a second border defined by a termination of the second image; and
the deterministic blending component of the blending function alters the one or more radiometric parameters of the first and second image pixel contributions for the one or more non-dithering pixels P(x,y) by assigning a first percentage of a total radiometric parameter value O to the first pixel contribution and a second percentage of a total radiometric parameter value O to the second pixel contribution such that the first and second percentages of each non-dithering pixel P(x,y) are based on the distance a of the non-dithering pixel P(x,y) from the first border and the distance b of the non-dithering pixel P(x,y) from the second border.

5. A display system as claimed in claim 4 wherein the deterministic blending component of the blending function as applied to the first display source is O*(bl(a+b)) and the deterministic blending component of the blending function as applied to the second display source is O*(al(a+b)) for a non-dithering pixel P(x,y) within the overlap region.

6. A display system as claimed in claim 1 wherein the display system is programmed such that the one or more dithering pixels P_{d}(x,y) are selected from the pixels within the overlap region of the multiple-display image in accordance with a probability distribution function.

7. A display system as claimed in claim 6 wherein the probability distribution function comprises a uniform probability distribution function.

8. A display system as claimed in claim 1 wherein every pixel within the overlap region of the multiple-display image is selected as a dithering pixel P_{d}(x,y).

9. A display system as claimed in claim 1 wherein the display system is programmed such that the one or more dithering pixels P_{d}(x,y) are selected from the pixels within the overlap region of the multiple-display image in accordance with a noise model corresponding to at least the pixels within the overlap region of the multiple-display image.

10. A display system as claimed in claim 9 wherein the display system is further programmed to:
sample the spatial noise model for a function value of a point within the noise model corresponding to a pixel P(x,y) within the overlap region;
compare the sampled function value to a reference value; and
select the pixel P(x,y) as a dithering pixel Pd(x,y) if the sampled function value satisfies a selection criteria.

11. A display system as claimed in claim 1 wherein:
the modification value X is determined by sampling a probability distribution function for the one or more dithering pixels P_{d}(x,y); and
the dithering component of the blending function alters the one or more radiometric parameters of the first and second image pixel contributions for the one or more dithering pixels P_{d}(x,y) by assigning a first percentage of a total radiometric parameter value O to the first pixel contribution and a second percentage of a total radiometric parameter value 0 to the second pixel contribution such that the first and second percentages of each dithering pixel P_{d}(x,y) are based on the distance a of the dithering pixel P_{d}(x,y) from the first border and the distance b of the dithering pixel P_{d}(x,y) from the second border and modifying the assigned percentages by applying the modification value X to the first and second percentages.

12. A display system as claimed in claim 11 wherein:
the dithering component of the blending function as applied to the first display source is:
$$O * ( \frac{( \frac{a}{a + b} ) * X}{( ( \frac{a}{a + b} ) * X ) + ( ( \frac{b}{a + b} ) * ( 1 - X ) )} ) ;$$
and
the dithering component of the blending function as applied to the second display source is:
$$O * ( \frac{( \frac{b}{a + b} ) * ( 1 - X )}{( ( \frac{a}{a + b} ) * X ) + ( ( \frac{b}{a + b} ) * ( 1 - X ) )} ) .$$

13. A display system as claimed in claim 11 wherein:
the probability function comprises a noise model having a plurality points;
each point of the spatial noise model corresponds with a respective pixel of the multiple-display image and comprises a function value; and
the one or more radiometric parameters of each dithering pixel P_{d}(x,y) is altered by the dithering component of the blending function such that the modification value X is determined by the function value of the point of the spatial noise model corresponding to the dithering pixel P_{d}(x,y) of the multiple-display image.

14. A display system as claimed in claim 11 wherein the probability function changes over time.

15. A display system as claimed in claim 1 wherein the modification value X is determined by a deterministic dithering function that is not based on a location of a dithering pixel P_{d}(x,y) within the overlap region.

16. A display system as claimed in claim 1 wherein the display system is further programmed to:
apply a probably distribution function comprising a plurality of points corresponding to the plurality of pixels of the multiple-display image to the first and display sources, each point having a function value;
sample the probability distribution function for the function value at points corresponding to pixels P(x,y) within the overlap region of the multiple image display;
compare the sampled function values for the points with a reference value;
select the dithering pixels Pd(x,y) where the sampled function value meets a selection criteria; and
sample the probability distribution function to obtain the modification value X for the respective dithering pixels P_{d}(x,y).

17. A display system as claimed in claim 1 wherein the display system comprises one or more additional display sources and the display system is configured such that one or more illuminated points within the multiple-display image. are illuminated by one or more of the display sources.

18. A method of displaying a multiple-display image comprising:
generating a first image comprising a plurality of illuminated points on a display surface;
generating a second image comprising a plurality of illuminated points on the display surface, thereby generating a multiple-display image comprising the first and second images, wherein at least a portion of the first image overlaps at least a portion of the second image in an overlap region of the multiple-display image such that each illuminated point within the overlap region of the multiple-display image comprises a first image pixel contribution generated by the first display source and a second image pixel contribution generated by the second display source;
selecting one or more dithering pixels P_{d}(x,y) from pixels within the overlap region;
altering one or more radiometric parameters of the first and second image pixel contributions for any non-dithering pixels P(x,y) within the overlap region of the multiple-display image; and
altering one or more radiometric parameters of the first and second image pixel contributions for one or more dithering pixels P_{d}(x,y) within the overlap region of multiple-display image based at least in part on a modification value X.

19. A method as claimed in claim 18 wherein:
the one or more radiometric parameters of the first and second image pixel contributions for the one or more non-dithering pixels P(x,y) are altered based at least in part on the location of the non-dithering pixel P(x,y) within the overlap region; and
the one or more radiometric parameters of the first and second image pixel contributions for the one or more dithering pixels P_{d}(x,y) are altered based at least in part on the location of the dithering pixel P_{d}(x,y) within the overlap region and the modification value X.

20. A method as claimed in claim 20 wherein the one or more dithering pixels P_{d}(x,y) are selected from the pixels within the overlap region of the multiple-display image in accordance with a probability distribution function.

21. A method as claimed in claim 20 wherein:
the overlap region comprises a first border defined by a termination of the first image and a second border defined by a termination of the second image; and
altering the one or more radiometric parameters of the first and second image pixel contributions for the one or more non-dithering pixels P(x,y) further comprises assigning a first percentage of a total radiometric parameter value O to the first pixel contribution and a second percentage of a total radiometric parameter value O to the second pixel contribution such that the first and second percentages of each of non-dithering pixel P(x,y) are based on the distance a of the non-dithering pixel P(x,y) from the first border and the distance b of the pixel P(x,y) from the second border.

22. A method as claimed in claim 20 wherein:
the modification value X is determined by sampling a probability distribution function for the one or more dithering pixels P_{d}(x,y); and
altering the one or more radiometric parameters of the first and second image pixel contributions for the one or more dithering pixels P_{d}(x,y) further comprises assigning a first percentage of a total radiometric parameter value O to the first pixel contribution and a second percentage of a total radiometric parameter value O to the second pixel contribution such that the first and second percentages of each dithering pixel P_{d}(x,y) are based on the distance α of the dithering pixel P_{d}(x,y) from the first border and the distance b of the dithering pixel P_{d}(x,y) from the second border, and applying the modification value X to the first and second percentages.

23. A display system comprising a first display source and a second display source, wherein:
the first display source is configured to generate a first image comprising a plurality of illuminated points on a display surface and the second display source is configured to generate a second image comprising a plurality of illuminated points on the display surface, thereby generating a multiple-display image comprising the first and second images;
the first display source and the second display source are configured such that at least a portion of the first image overlaps at least a portion of the second image in an overlap region of the multiple-display image, wherein each illuminated point within the overlap region of the multiple-display image comprises a first image pixel contribution generated by the first display source and a second image pixel contribution generated by the second display source; and
the display system is programmed to sequentially apply two or more blending functions to the first and second display sources, wherein the blending functions are configured to alter one or more radiometric parameters of the first and second image pixel contributions for one or more pixels P(x,y) within the overlap region of the multiple-display image.

24. A display system as claimed in claim 23 wherein each of the two or more blending functions alters the one or more radiometric parameters of the first and second pixel contributions in a manner that is different than the remaining blending functions.
